(19) United States
(12) Patent Application Publication
(10) Pub. No.: US 2025/0076586 A1
(43) Pub. Date: Mar. 6, 2025

(54) OPTICAL MEMBER

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: HIROSHI ANDO, Nisshin-shi (JP); KOJIRO TACHI, Nisshin-shi (JP)

(21) Appl. No.: 18/745,226

(22) Filed: Jun. 17, 2024

(30) Foreign Application Priority Data
Aug. 28, 2023 (JP) 2023-138110

(51) Int. Cl. G02B 6/34

(52) U.S. Cl. CPC G02B 6/34

(57) ABSTRACT

An optical member includes a light guide made of a light-transmitting material. The light guide has an entrance surface, an exit section that outputs a part of light incident from the entrance surface to outside, a smooth surface opposite to the exit section, and a terminal surface located opposite to the entrance surface to connect the exit section and the smooth surface. The exit section has a first region adjacent to the entrance surface and a second region adjacent to the first region. The first region has a step-shaped reflective surface and a prism part alternately arranged adjacent to each other. The step-shaped reflective surface has plural flat surfaces located at different heights through a step portion.

### CROSS REFERENCE TO RELATED APPLICATION

This application is based on Japanese Patent Application No. 2023-138110 filed on Aug. 28, 2023, the disclosure of which is incorporated herein by reference.

### TECHNICAL FIELD

The present disclosure relates to an optical member that internally reflects a part of light incident from an entrance surface and emits the incident light and the reflected light to outside from a surface different from the entrance surface.

### BACKGROUND

An optical member is attached to a light shielding body, to allow outside light from a blind spot area generated by the light shielding body to enter the optical member. The light is reflected inside the optical member, to emit the light from a surface different from the entrance surface. Thus, the blind spot area becomes visible by confirming the light, since the optical member functions as a blind spot auxiliary device.

### SUMMARY

According to one aspect of the present disclosure, an optical member includes a light guide made of a light-transmitting material. The light guide has an entrance surface, an exit section that outputs a part of light incident from the entrance surface to outside, a smooth surface opposite to the exit section, and a terminal surface located opposite to the entrance surface and connecting the exit section and the smooth surface. The exit section has a first region adjacent to the entrance surface and a second region adjacent to the first region. The first region has a step-shaped reflective surface and a prism part alternately arranged adjacent to each other. The step-shaped reflective surface has a plurality of flat surfaces located at different heights through a step portion.

### BRIEF DESCRIPTION OF DRAWINGS

FIG. 1 is a cross-sectional view illustrating an optical member according to a first embodiment.

FIG. 2 is an explanatory diagram of a light guide in the optical member of FIG. 1.

FIG. 3 is an enlarged view of an area Ill in FIG. 1 to explain a light guide in the first region of the exit section.

FIG. 4 is a diagram, corresponding to FIG. 3, to explain a pitch interval of the prism parts, a pitch interval of reflected lights, and a step difference of a step portion in the first region of the exit section.

FIG. 5 is a diagram of a light guide in an optical member of a comparative example that does not have a step-shaped flat part.

FIG. 6 is a diagram to explain an occurrence of moire in the optical member of the comparative example of FIG. 5.

FIG. 7 is a cross-sectional view illustrating an optical member according to a second embodiment.

FIG. 8 is an explanatory diagram of a light guide in the optical member of FIG. 7.

FIG. 9 is an enlarged view of an area IX in FIG. 7, to explain a light guide in the first region of the exit section.

FIG. 10 is a diagram, corresponding to FIG. 9, to explain a pitch interval of the refractive index difference layers, a pitch interval of reflected lights, and a step difference of a step portion in the first region of the exit section.

FIG. 11 is a cross-sectional view illustrating an optical member according to a modification of the second embodiment.

FIG. 12 is a cross-sectional view illustrating an optical member according to a third embodiment.

FIG. 13 is an explanatory diagram of a light guide in the optical member of FIG. 12.

FIG. 14 is an enlarged view of an area XIV in FIG. 12, to explain a light guide in the first region of the exit section.

FIG. 15 is a diagram, corresponding to FIG. 14, to explain a pitch interval of the refractive index difference layers, a pitch interval of reflected lights, and a step difference of a step portion in the first region of the exit section.

FIG. 16 is a cross-sectional view illustrating an optical member according to a fourth embodiment.

FIG. 17 is an explanatory diagram of a light guide in the optical member of FIG. 16.

FIG. 18 is an enlarged view of an area XVIII in FIG. 16, to a explain light guide on a step-shaped reflective surface.

FIG. 19 is a diagram, corresponding to FIG. 18, to explain a width of the step-shaped reflective surface, a step difference and an inclination angle of a step portion.

FIG. 20 is a cross-sectional view illustrating an optical member according to another embodiment.

FIG. 21 is an enlarged cross-sectional view of an area XXI in FIG. 20.

FIG. 22 is a cross-sectional view illustrating an optical member according to another embodiment.

### DETAILED DESCRIPTION

An optical member is attached to, for example, a light shielding body, to allow outside light from a blind spot area, due to the light shielding body, to enter the optical member. The light is reflected inside the optical member, to emit the light from a surface different from the entrance surface. Thus, the blind spot area becomes visible by confirming the light, since the optical member functions as a blind spot auxiliary device.

The optical member is composed of a light guide, and a part of external light that enters from the entrance surface of the light guide is guided internally by total reflection. The guided light is emitted to outside from an exit surface different from the entrance surface. Thus, the user facing the exit surface can view the scene in the blind spot area. This creates a half-mirrorless structure that does not require a half mirror made of a reflective material different from the light guide on the exit side, and it is possible to reduce loss due to absorption of external light by the light guide inside the light guide.

The exit section of the optical member has prisms and flat parts alternately arranged along a direction connecting the entrance surface and a terminal surface. In this optical member, since the exit section has a pattern structure of the prism parts and the flat parts, the incident light that reaches the exit section is reflected according to the pattern of the flat parts.

As a result of intensive studies by the present inventors regarding this optical member, it is found that the reflected light with a predetermined pattern at the exit section is guided by total reflection inside the light guide, and the interval of the pattern changes, when the light reaches the exit section again, such that moire occurs due to the relationship with the structural pattern of the exit section.

The present disclosure provides an optical member including a light guide to guide an incident light from an entrance surface by total reflection, so as to suppress the occurrence of moire due to a relationship between the reflected light with a predetermined pattern at the exit section and the pattern structure of the exit section.

According to one aspect of the present disclosure, an optical member includes a light guide made of a light-transmitting material. The light guide has an entrance surface, an exit section that outputs a part of light incident from the entrance surface to outside, a smooth surface opposite to the exit section, and a terminal surface located opposite to the entrance surface and connecting the exit section and the smooth surface. The exit section has a first region adjacent to the entrance surface and a second region adjacent to the first region. The first region has a step-shaped reflective surface and a prism part alternately arranged adjacent to each other. The step-shaped reflective surface has flat surfaces located at different heights through a step portion.

In the optical member, light incident from the entrance surface enters the step-shaped reflective surface located in a first region of the exit section, and is reflected by total internal reflection, in a divided manner, by the flat surfaces of the step-shaped reflective surface, so as to be guided to the second region of the exit section. As a result, in this optical member, the pitch interval of the reflected lights that reach the second region is greatly different from the pattern interval of the prism parts and the flat parts in the second region, to reduce the occurrence of moire in the second region.

According to another aspect of the present disclosure, an optical member configured to internally reflect and guide an external light includes: a light guide made of a light-transmitting material and having an entrance surface on which the external light is incident, an exit section that outputs a part of light incident from the entrance surface to outside, a smooth surface opposite to the exit section, and a terminal surface located opposite to the entrance surface and connecting the exit section and the smooth surface, in which the exit section has protruding prism parts and flat parts to be a flat surface; and a plurality of refractive index difference layers having a refractive index lower than that of the light guide and located in a region where at least an incident light that is incident from the entrance surface directly enters, adjacent to the exit section inside of the light guide. Each of the refractive index difference layers has flat surfaces arranged at different heights through a step portion, opposite to a plane formed by the smooth surface. The flat surfaces, the flat parts, and the smooth surface reflect a part of the incident light by total reflection. The prism part has an exit surface that outputs a part of the incident light to outside, and the refractive index difference layers are distanced from each other not to block the incident light that enters the exit surface.

In this optical member, the light incident from the entrance surface enters the refractive index difference layer in a predetermined region near the exit section, where the light directly enters, and is reflected by total reflection, in a divided manner, by the flat surfaces of the refractive index difference layer, so as to be guided into a region of the exit section where no refractive index difference layer is provided. As a result, in this optical member, the pitch interval of the reflected lights that reached the region where no refractive index difference layer is provided in the exit section is greatly different from the pattern interval of the prism parts and the flat parts in that region. Thus, the occurrence of moire can be reduced.

According to another aspect of the present disclosure, an optical member configured to internally reflect and guide an external light includes: a light guide made of a light-transmitting material and having an entrance surface on which the external light is incident, an exit section that outputs a part of light incident from the entrance surface to outside, a smooth surface and a dividing reflection section opposite to the exit section, and a terminal surface located opposite to the entrance surface and connecting the exit section and the smooth surface. The exit section has protruding prism parts and flat parts to be a flat surface. The dividing reflection section is adjacent to the smooth surface and located between the entrance surface and the smooth surface. The dividing reflection section has step-shaped reflective surfaces arranged adjacent to each other in which reflective surfaces are located at different heights through a step portion, opposite to a surface formed by the flat parts. The reflective surfaces, the flat parts, and the smooth surface reflect a part of incident light that is incident on the light guide from the entrance surface by total reflection, and the prism part has an exit surface that outputs a part of the incident light to outside.

In this optical member, the light enters the dividing reflection section where the light reflected from the area of the exit section where the light incident from the entrance surface directly enters, and is reflected by total internal reflection, in a divided manner, by the reflective surfaces of the dividing reflection section, to be guided to the next region of the exit section. As a result, in this optical member, the pitch interval of the reflected lights that reached the next region of the exit section is greatly different from the pattern interval of the prism parts and the flat parts in the next region, such that the occurrence of moire can be reduced.

Hereinafter, embodiments of the present disclosure will be described with reference to the drawings. In the following embodiments, the same or equivalent parts are denoted by the same reference numerals as each other, and explanations will be provided to the same reference numerals.

### First Embodiment

An optical member 1 according to a first embodiment of the present disclosure will be described with reference to the drawings.

The optical member 1 of this embodiment is attached to a member or obstacle that obstructs the user's field of view. The optical member 1 can be used as a blind spot auxiliary device that allows the user to see the scene in the blind spot. For example, in the case of in-vehicle use, the optical member 1 is attached to a predetermined light shielding body such as a pillar of the vehicle, and guides external light from an area that becomes a blind spot due to the pillar toward the user, to allow the user to visually recognize a scene in the blind spot.

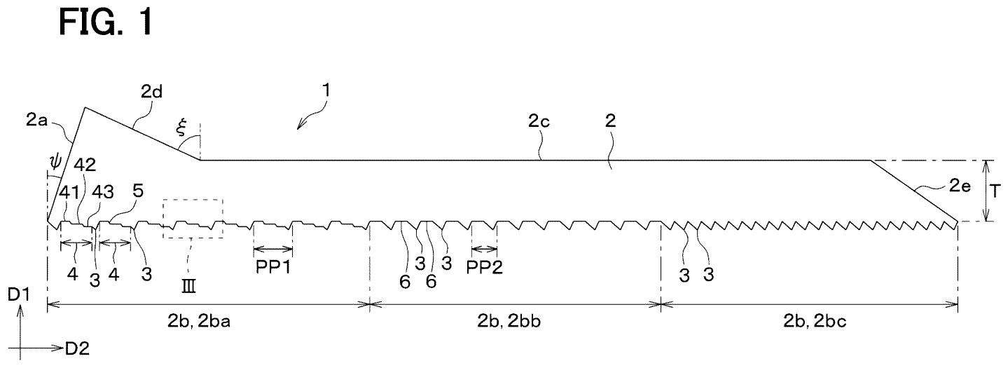

As shown in FIG. 1, the optical member 1 of this embodiment includes a light guide 2 having an entrance surface 2a, an exit section 2b, a smooth surface 2c, a sloped surface 2d, and a terminal surface 2e.

Hereinafter, for convenience of explanation, as shown in FIG. 1, for example, the exit section 2b and the smooth surface 2c are located opposite to each other in a direction along a normal direction to a flat part 6 of the optical member 1, which will be described later, or the smooth surface 2c. The direction connecting the exit section 2b and the smooth surface 2c is referred to as “thickness direction D1.” A direction perpendicular to the thickness direction D1 and extended from the entrance surface 2a toward the terminal surface 2e is referred to as “light guiding direction D2” in which the light incident from the entrance surface 2a is guided. The light guiding direction D2 can also be called as arrangement direction along which prism parts 3 and flat parts 6, which will be described later, are repeatedly arranged, and is perpendicular to a protruding direction of the prism part 3.

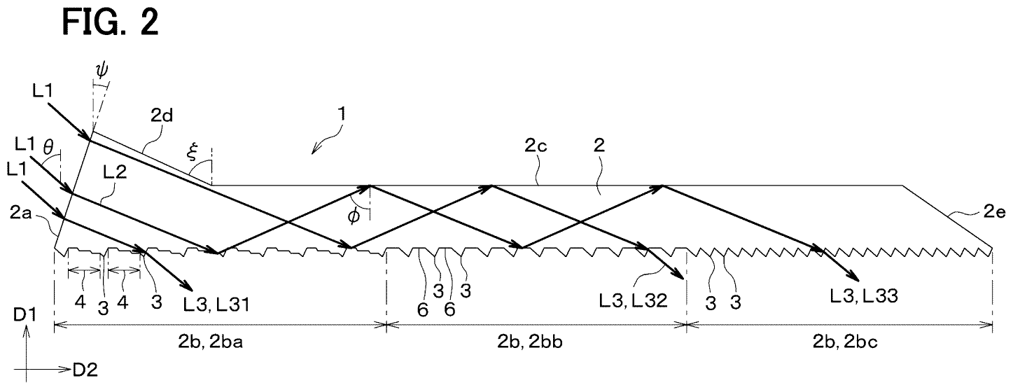

As shown in FIG. 2, in the optical member 1, a part of light incident on the light guide 2 from the entrance surface 2a is reflected at the exit section 2b, and the light reflected at the exit section 2b is reflected at the smooth surface 2c toward the exit section 2b again. For example, the optical member 1 guides external light from the entrance surface 2a inside the light guide 2 and emits the light to the outside from the exit section 2b, so that the user facing the exit section 2b can see the outside scenery of the blind area.

Hereinafter, for convenience of explanation, as shown in FIG. 2, an external light that enters the entrance surface 2a will be referred to as “external light L1”, and a light that entered the light guide 2 from the entrance surface 2a will be referred to as “incident light L2”. The light emitted from the light guide 2 to the outside will be referred to “emitted light L3.” A part of the emitted light L3 emitted from the first region 2ba of the exit section 2b will be referred to “first emitted light L31.” A part of the emitted light L3 emitted from the second region 2bb is referred to as “second emitted light L32.” A part of the emitted light L3 emitted from the third region 2bc is referred to as “third emitted light L33”.

The light guide 2 is a substantially plate-shaped single member made of a light-transmitting material, for example, a glass or resin material such as polyethylene terephthalate, polycarbonate, polyethylene, or acrylic. The light guide 2 is formed, for example, by a resin molding method using a mold (not shown). In the light guide 2, a part of the incident light L2 from the entrance surface 2a enters the prism part 3 of the exit section 2b, and the remaining part of the incident light L2 is reflected by flat surfaces 41 to 43 or a flat part 6, which will be described later. This reflected light is directed toward the smooth surface 2c. The light guide 2 is designed so that the incident light L2 reflected by the flat surfaces 41 to 43 or the flat part 6 is totally reflected by the smooth surface 2c to be guided inside. Specifically, the constituent material of the light guide 2 has a refractive index of no, and the incident angle of the incident light L2 with respect to the smooth surface 2c, the flat surface 41 to 43, and the flat part 6 is set as q. When the external medium of the light guide 2 is an air layer with a refractive index of 1, the light guide 2 is designed to satisfy Formula 1. The incident angle q is defined between the travelling direction of the incident light L2 that enters the flat surface 41 to 43, the flat part 6, or the smooth surface 2c and the thickness direction D1, and may also be referred to as the light guide angle φ.

sin φ>1/n₀ (Formula 1)

As a result, even while the light guide 2 does not have a half mirror or a mirror made of a reflective material different from the light guide 2, a part of the incident light L2 is repeatedly reflected between the flat part 6 and the smooth surface 2c. The incident light L2 is emitted to the outside from the exit surface 3a of the prism part 3, which will be described later.

The entrance surface 2a allows the external light L1 to enter the interior. The entrance surface 2a is located adjacent to the exit section 2b and extends in a direction intersecting the exit section 2b and the smooth surface 2c. The entrance surface 2a is, for example, a flat surface inclined to approach the terminal surface 2e as going toward the smooth surface 2c, and has an inclination angle of w with respect to the thickness direction D1. The inclination angle ψ of the entrance surface 2a is smaller than the light guide angle q. At this time, when an angle of the external light L1 with respect to the thickness direction D1 is defined as θ, if ψ<π/2−φ is satisfied according to the refraction condition, the incident light L2 is refracted in a direction such that the light guide angle φ becomes larger than the angle θ of the external light L1, and the light is guided to a wider range of the exit section 2b. The angle θ can also be said as an incidence angle of the external light L1 on the light guide 2. In the light guide 2, for example, q is the total reflection angle, and the refractive index of the normal translucent resin material is 1. Due to the relationship of n₀·sin φ>1, φ>45.3 is satisfied, such that the structure satisfies the relationship of φ>ψ.

The exit section 2b is formed at a position adjacent to and intersecting the entrance surface 2a, and includes the first region 2ba, the second region 2bb and the third region 2bc having different configurations. The exit section 2b serves as a so-called reflective exit surface that reflects a part of the incident light L2 toward the smooth surface 2c and emits a part of the incident light L2 to the outside.

The first region 2ba has, for example, plural prism parts 3 which are triangular protrusions in a cross-sectional view, and plural step-shaped reflective surfaces 4 alternately and repeatedly arranged from the entrance surface 2a toward the terminal surface 2e. The incident light L2 from the entrance surface 2a directly enters the first region 2ba. That is, the incident light L2 from the entrance surface 2a enters the first region 2ba without being reflected even once.

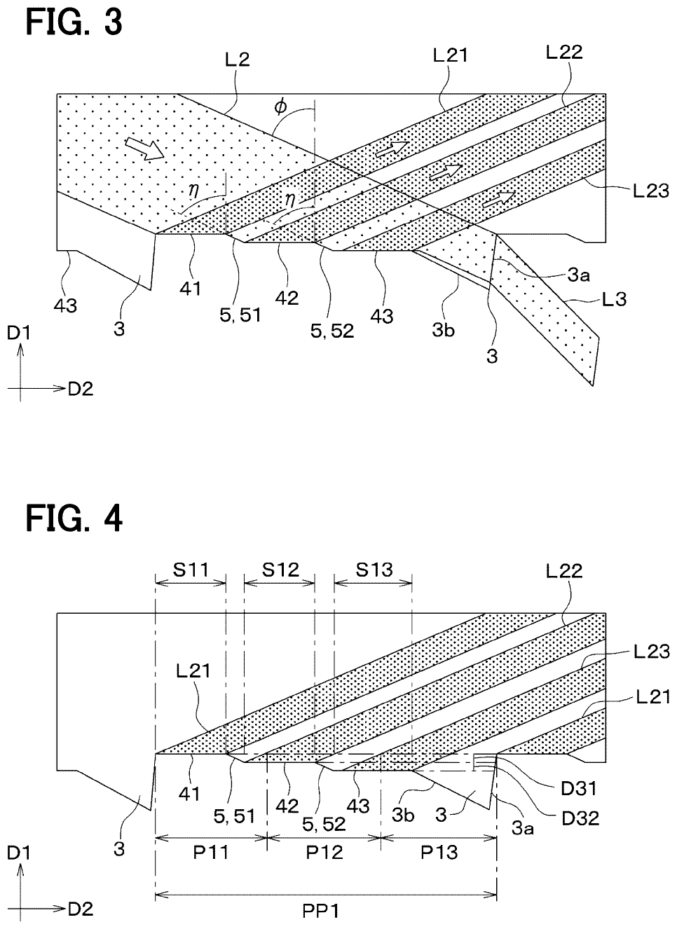

The prism parts 3 are protrusions protruding from the step-shaped reflective surface 4, and are arranged in parallel, for example, such that the height in the thickness direction D1 and the width in the light guiding direction D2 are approximately the same. In this specification, “approximately the same” includes not only completely the same case but also a case where there is a slight difference due to unavoidable factors such as processing errors, but almost the same. As shown in FIG. 3, the prism part 3 includes an exit surface 3a that is parallel to the entrance surface 2a, when viewed in the cross-section, to emit a part of the incident light L2 to the outside, and the other surface 3b adjacent to the exit surface 3a. For example, the exit surface 3a of the prism parts 3 is parallel to the entrance surface 2a, that is, having an inclination angle of w with respect to the thickness direction D1. As a result, a part of the incident light L2 that reaches the exit surface 3a is emitted to the outside as the emitted light L3 at the same angle θ as the external light L1. Therefore, as viewed from the user located adjacent to the exit section 2b, continuity is ensured between the external view not via the optical member 1 and the external view in the blind area made visible by the optical member 1. The pitch interval of the prism parts 3 adjacent to each other in the light guiding direction D2 is different among the first region 2ba, the second region 2bb, and the third region 2bc. Hereinafter, the pitch interval between the prism parts 3 adjacent to each other in the light guiding direction D2 will be referred to as “prism pitch.” For example, the prism pitch is constant in each of the regions 2ba to 2bc.

The step-shaped reflective surface 4 has, for example, a first flat surface 41, a second flat surface 42, and a third flat surface 43, which are flat surfaces substantially parallel to the smooth surface 2c, and a step portion 5 located between the flat surfaces. In this specification, “substantially parallel” includes not only completely parallel cases but also substantially parallel cases with slight differences due to processing errors and the like.

Hereinafter, for convenience, the step portion 5 connecting the first flat surface 41 and the second flat surface 42 will be referred to as a “first step portion 51”, and the step portion 5 connecting the second flat surface 42 and the third flat surface 43 will be referred to as a “second step portion 52”.

In the step-shaped reflective surface 4, for example, the first flat surface 41, the first step portion 51, the second flat surface 42, the second step portion 52, and the third flat surface 43 are arranged in this order from the entrance surface 2a. The step-shaped reflective surface 4 functions as a reflective surface whose flat surfaces 41 to 43 reflect the incident light L2. In the step-shaped reflective surface 4, for example, the flat surfaces 41 to 43 are located at different positions in the thickness direction D1, and the flat surface closer to the prism part 3 adjacent to the terminal surface 2e is located farther from the light guide 2. Of the two prism parts 3 adjacent to the step-shaped reflective surface 4, the prism part 3 adjacent to the terminal surface 2e refers to one of them located adjacent to the terminal surface 2e.

Hereinafter, for convenience of explanation, the position in the thickness direction D1 will be referred to as a “height position.” An upward direction is defined to extend from the exit section 2b toward the smooth surface 2c in the thickness direction D1. A downward direction is defined to extend from the smooth surface 2c to the exit section 2b in the thickness direction D1.

In the step-shaped reflective surface 4, the height position of the first flat surface 41 is approximately the same as that of the flat part 6. The height position is lowered in order of the first flat surface 41, the second flat surface 42, and the third flat surface 43, like a stair structure. The step-shaped reflective surface 4 is provided to suppress the occurrence of moire caused by the difference in the pitch interval of the reflected lights and a structural pitch of the prism part 3 and the flat part 6 in the second region 2bb, when the reflected light of the incident light L2 reaches the second region 2bb. The details will be described later.

The second region 2bb includes, for example, plural prism parts 3 and plural flat parts 6, alternately and repeatedly arranged from the entrance surface 2a toward the terminal surface 2e. The flat parts 6 form, for example, a flat surface opposite to the smooth surface 2c and are arranged substantially parallel to the smooth surface 2c. For example, the flat parts 6 are arranged on the same plane. Since the incident light L2 from the entrance surface 2a is incident on the flat part 6 at an angle equal to or greater than the critical angle, the flat part 6 functions as a reflective surface to reflect the incident light L2 toward the smooth surface 2c by total reflection. The prism pitch PP2 in the second region 2bb is smaller than, for example, the prism pitch PP1 in the first region 2ba. In other words, the width of the reflecting portion between the adjacent prism parts 3 to reflect the incident light L2 in the light guiding direction D2 in the second region 2bb is smaller than that in the first region 2ba.

The third region 2bc is composed only of plural prism parts 3, which are repeatedly arranged along the light guiding direction D2. The third region 2bc does not have a reflecting portion that reflects the incident light L2 toward the smooth surface 2c, and serves as an exit region that emits the incident light L2 that has reached to the outside.

The exit section 2b is constituted by the regions 2ba to 2bc among which the ratio of the reflection width of the incident light L2 in the light guiding direction D2 and the emission width in the light guiding direction D2 emitted to the outside is different. Therefore, it is possible to make the light quantities of the emitted lights L31 to L33 substantially uniform. The “substantially uniform” includes not only completely the same case, but also a case where there is a slight difference due to unavoidable factors such as processing errors, but almost the same. In this specification, the number of regions constituting the exit section 2b is three as a representative example, but is not limited to this, and the number of regions can be changed as appropriate.

The sloped surface 2d connects the entrance surface 2a and the smooth surface 2c, and is inclined at an inclination angle ζ with respect to the thickness direction D1 to be closer to the terminal surface 2e as approaching the smooth surface 2c. The sloped surface 2d protrudes from the smooth surface 2c. In other words, the entrance surface 2a and the sloped surface 2d constitute one large protruding prism part when viewed in the cross-section. That is, in the light guide 2, the height in the thickness direction D1 of one prism part formed by the entrance surface 2a and the sloped surface 2d is greater than the height T of the exit section 2b from the flat part 6 to the smooth surface 2c. Thereby, the area of the exit section 2b where the incident light L2 from the entrance surface 2a first reaches the light guide 2 can be widened.

The terminal surface 2e connects the exit section 2b and the smooth surface 2c. The terminal surface 2e is, for example, one flat surface. Although the inclination of the terminal surface 2e is not fixed, for example, the terminal surface 2e forms one flat surface together with the exit surface 3a of the prism part 3 which is the closest to the terminal surface 2e, of the exit section 2b, and may function as the last exit surface in the light guiding direction D2.

A side surface of the light guide 2 connecting the entrance surface 2a, the exit section 2b, the smooth surface 2c, the sloped surface 2d, and the terminal surface 2e at both ends in a direction orthogonal to the plane formed by the thickness direction D1 and the light guiding direction D2 does not contribute optically, and its shape, configuration, and the like are not limited.

The above is the basic configuration of the optical member 1.

Next, details of the step-shaped reflective surface 4 and its effects will be explained with reference to the drawings.

In FIGS. 3 to 5, in order to make it easier to understand a light guide in the optical member 1 and an optical member of a comparative example, the lights that entered the optical member are hatched, while they are not cross-sections. The traveling direction of the incident light L2 and its reflected light is indicated by a blank arrow.

As shown in FIG. 3, the step-shaped reflective surface 4 reflects the incident light L2 on three flat surfaces 41 to 43 arranged with the step portion 5 in between. In other words, the step-shaped reflective surface 4 divides and reflects the incident light L2 on the plural flat surfaces, and makes the pitch of the reflected lights less than a half of the prism pitch PP1.

Hereinafter, for convenience of explanation, the incident light L2 reflected by the first flat surface 41 will be referred to as “first reflected light L21.” The incident light L2 reflected by the second flat surface 42 will be referred to as “second reflected light L22.” The incident light L2 reflected by the third flat surface 43 will be referred to as “third reflected light L23.”

In the step-shaped reflective surface 4, the first step portion 51 and the second step portion 52 are flat inclined surfaces having substantially the same inclination angle with respect to the thickness direction D1. It is preferable that the step portion 51, 52 has an inclination angle of n with respect to the thickness direction D1, and that the inclination angle η is less than or equal to the light guide angle q of the incident light L2, that is, η≤φ. As a result, the incident light L2 having the light guide angle φ reaches the second flat surface 42 and the third flat surface 43 without being blocked by the step portion 51, 52. While unintended reflection at the step portion 51, 52 is suppressed, loss of light rays can be restricted.

The step portion 51, 52 does not need to obstruct the incident light L2 that is directed toward the second flat surface 42 and the third flat surface 43, and may have a curved shape or/and a flat part without being limited to a planar shape.

The step-shaped reflective surface 4 reflects the incident light L2 in a divided manner using the flat surfaces 41 to 43, thereby making the pitch intervals P11 to P13 of the reflected lights L21 to L23 less than half of the prism pitch PP1. The pitch interval P11 is defined between the first reflected light L21 and the second reflected light L22 in the light guiding direction D2, as shown in FIG. 4. The pitch interval P12 is defined between the second reflected light L22 and the third reflected light L23 in the light guiding direction D2. The pitch interval P13 is defined between the third reflected light L23 and the first reflected light L21 on another step-shaped reflective surface 4 adjacent to the third flat surface 43 in the light guiding direction D2. The step-shaped reflective surface 4 divides the incident light L2 into the reflected lights L21 to L23 with the pitch intervals P11 to P13 that are significantly different from the prism pitch PP1, thereby suppressing the occurrence of moire in the second region 2bb.

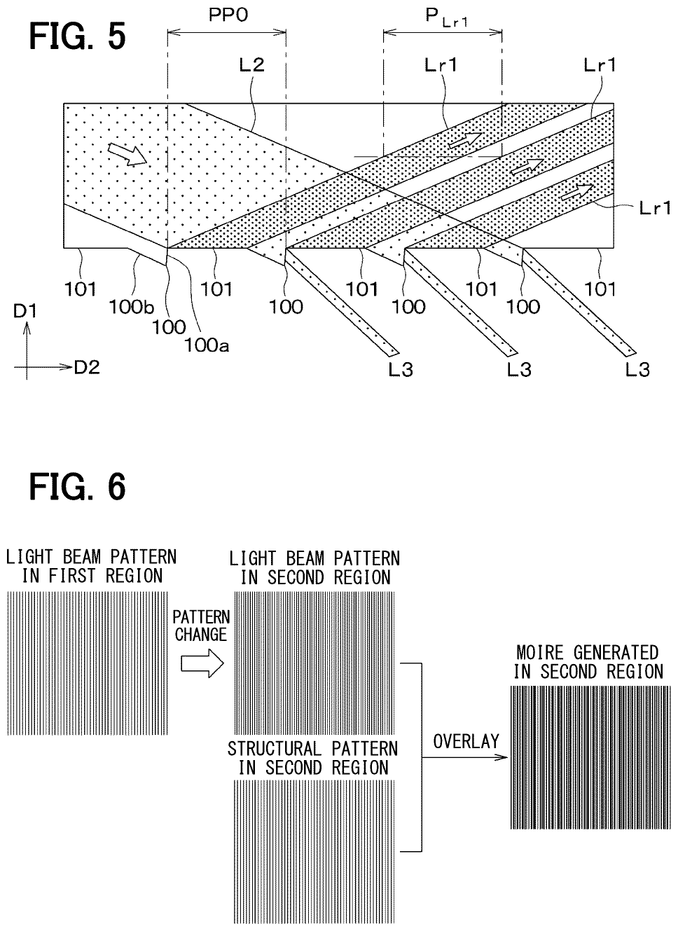

An occurrence of moire in an optical member of a comparative example that does not have the step-shaped reflective surface 4 will be described with reference to FIG. 5.

In the optical member of the comparative example, prism parts 100 having triangular projection shapes and flat parts 101 forming a flat surface are alternately and repeatedly arranged in an exit section in a cross-sectional view. The comparative example differs from the optical member 1 in that the pitch is constant over the entire area of the exit section. In other words, in the optical member of the comparative example, the structural pitch of the prism parts and the flat parts in the exit section is the same over the entire area. In the optical member of the comparative example, a part of the incident light L2 is totally reflected by the flat part 101 toward a smooth surface, and a part of the incident light L2 is emitted to the outside from the exit surface 100a of the prism part 100. A part of the incident light L2 that is reflected by the flat part 101 is defined as reflected light Lr1. The pitch interval PLr1 of the reflected lights Lr1 in the light guiding direction D2 matches the prism pitch PP0 of the prism parts 100.

The reflected light Lr1 is guided inside the optical member of the comparative example and reaches the exit section again. However, since there is a distance until it reaches the exit section again, the pitch interval PLr1 of the reflected lights Lr1 changes to be smaller. In the exit section of the optical member of the comparative example, the area where the incident light L2 first reaches is called as a first region, and the area where the incident light L2 reflected at the first region reaches is called as a second region. The pitch interval PLr1 is smaller in the second region than in the first region.

In the optical member of the comparative example, since the prism pitch PP0 is constant over the entire area of the exit section, a slight deviation occurs between the prism pitch PP0 and the pitch interval PLr1 in the second region. Therefore, in the optical member of the comparative example, as shown in FIG. 6, for example, a slight deviation occurs between the light beam pattern of the reflected light in the second region and the structural pattern of the prism part 100 and the flat part 101. In this case, moire may occur. When moire occurs, the visibility of the scene viewed at the exit section is reduced. In this case, in the optical member of the comparative example, the visibility of the scene in the blind spot region may be reduced.

In FIG. 6, the brightness/darkness of the light beam pattern and the brightness/darkness of the structural pattern are shown by white and black patterns. In FIG. 6, “bright” in the light beam pattern and the structural pattern is shown in white and corresponds to a portion from which the emitted light L3 is emitted. In FIG. 6, “dark” in the light beam pattern and the structural pattern is shown in black and corresponds to a portion from which the emitted light L3 is not emitted. FIG. 6 is a diagram showing a brightness/darkness pattern when viewed from the normal direction to the flat part 101 of the exit section.

Moire strongly occurs when the difference between the pitch interval PLr1 of the reflected lights Lr1 and the prism pitch PP0 is less than a predetermined value. When this difference increases, the period of the moire becomes finer and becomes less noticeable. Further, moire does not occur if the pitch interval PLr1 and the prism pitch PP0 match or is an integer multiple. Therefore, in order to reduce moire, it is conceivable to make the prism pitch PP0 of the first region sufficiently smaller than that of the second region in the optical member of the comparative example.

However, in this case, the size of the prism part 100 is decreased, and the area of the exit surface 100a become smaller. In this case, the emitted light L3 in the first region is affected by diffraction due to the reduction in the area of the exit surface 100a. For this reason, if the prism pitch PP0 of the first region is simply reduced, although moire can be reduced, the blur of the scene viewed in the first region becomes large, and the visibility of the scene in the blind spot area decreases.

In contrast, in the optical member 1 of the present embodiment, the step-shaped reflective surfaces 4 are arranged in the first region 2ba of the exit section 2b and divides the incident light L2 into plural reflected lights L21 to L23. Therefore, the pitch intervals P11 to P13 of the reflected lights L21 to L23 are greatly different from the prism pitch PP1. Furthermore, when the reflected lights L21 to L23 reach the second region 2bb, the difference between the pitch interval P11 to P13 and the prism pitch PP2 becomes large. As a result, the optical member 1 can suppress the occurrence of moire in the second region 2bb.

Further, the optical member 1 has the step-shaped reflective surface 4, and the height position of the flat surface is lowered as approaching the terminal surface 2e, such that the area of the exit surface 3a of the prism part 3 is secured as large. Therefore, in the optical member 1, the effect of diffraction on the emitted light L3, due to the area of the exit surface 3a, is reduced, and it is possible to suppress a decrease in the visibility of the scene viewed at the exit section 2b.

As shown in FIG. 4, the widths of the reflected lights L21 to L23 in the light guiding direction D2 are defined respectively as S11, S12, and S13, and the lengths of the step portions 51 and 52 in the thickness direction D1 are defined respectively as D31 and D32. At this time, the pitch interval P11 is expressed by Formula 2 in the first region 2ba, and the pitch interval P12 is expressed by Formula 3 in the first region 2ba.

$$P 11 = S 11 + 2 \times D 31 \times tan φ \qquad ( Formula 2 )$$

$$P 12 = S 12 + 2 \times D 32 \times tan φ \qquad ( Formula 3 )$$

In this specification, the step-shaped reflective surface 4 has three flat surfaces as a representative example, but not limited to this. The number of steps is defined as m (m: integer larger than or equal to 2), and the number of flat surfaces is defined as m+1, where m can be changed as appropriate. For example, the reflected light at the m^{th} flat surface (4m) counting from the entrance surface 2a, of the step-shaped reflective surface 4, is defined as the m^{th} reflected light (L2m), and the reflected light at the (m+1)^{th} flat surface 4 (m+1) is defined as the (m+1)^{th} reflected light L2 (m+1). The widths of the m^{th} reflected light (L2m) and the (m+1)^{th} reflected light L2 (m+1) in the light guiding direction D2 are respectively defined as (S1m) and S1 (m+1). The width of the m^{th} step portion (5m) counting from the entrance surface 2a in the thickness direction D1 is defined as (D3m). At this time, the pitch interval (P1m) of the m^{th} reflected light (L2m) and the (m+1)^{th} reflected light L2 (m+1) is expressed by Formula 4 in the first region 2ba.

$$P 1 m = S 1 m + 2 \times D 3 m \times tan φ \qquad ( Formula 4 )$$

From the viewpoint of moire reduction, each of the pitch intervals P11 to (P1m) may be half or less of the prism pitch PP1, and does not need to be substantially the same. However, if they are made substantially the same, the light intensity of the emitted light L3 can be made approximately uniform. This is because the first reflected light L21 to the m^{th} reflected light (L2m) directed toward the second region 2bb are approximately equally spaced, when the pitch intervals P11 to (P1m) are approximately the same. That is, since the light amount is approximately the same, variations in the amount of light emitted are reduced between the second region 2bb and the third region 2bc. When the pitch intervals P11 to (P1m) are approximately the same, in the step-shaped reflective surface 4, for example, the widths D31 to (D3m) of the first step portion 51 to the m^{th} step portion (5m) are approximately the same, and the widths S11 to S1(m+1) of the first flat surface 41 to the (m+1)^{th} flat surface 4(m+1) are approximately the same.

Furthermore, since the step portion 5 of the step-shaped reflective surface 4 and the other surface 3b of the prism part 3 do not contribute optically, it may be covered with a light-shielding film (not shown) such that external light from the exit section 2b is restricted from entering the light guide 2.

According to this embodiment, in the first region 2ba of the exit section 2b, into which the incident light L2 from the entrance surface 2a directly enters, the prism part 3 and the step-shaped reflective surface 4 are alternately and repeatedly arranged, and a part of the incident light L2 is divided and reflected by the flat surfaces 41 to 43. In this optical member 1, a part of the incident light L2 is divided into the plural reflected lights L21 to L23, and the pitch intervals P11 to P13 of the reflected lights L21 to L23 are largely deviated from the prism pitch PP1 of the prism part 3. Therefore, in the optical member 1, the pitch intervals P11 to P13 of the reflected lights L21 to L23 are significantly different from the prism pitch PP2 of the second region 2bb, making it possible to reduce moire.

(1) In the present embodiment, in the optical member 1, the flat surfaces 41 to 43 of the step-shaped reflective surface 4 are located downward in the thickness direction D1 as the flat surface becomes closer to the prism part 3 adjacent to the terminal surface 2e. Thereby, in the optical member 1, it is possible to ensure the area of the exit surface 3a of the prism part 3 to be larger than a predetermined value, so as to reduce the influence of diffraction of the emitted light L3 in the first region 2ba. In other words, this optical member 1 is able to reduce moire caused by the periodic structure of the prism parts 3 and the reflective surfaces, due to total reflection, while ensuring the visibility of the scene in the blind spot area.

### Second Embodiment

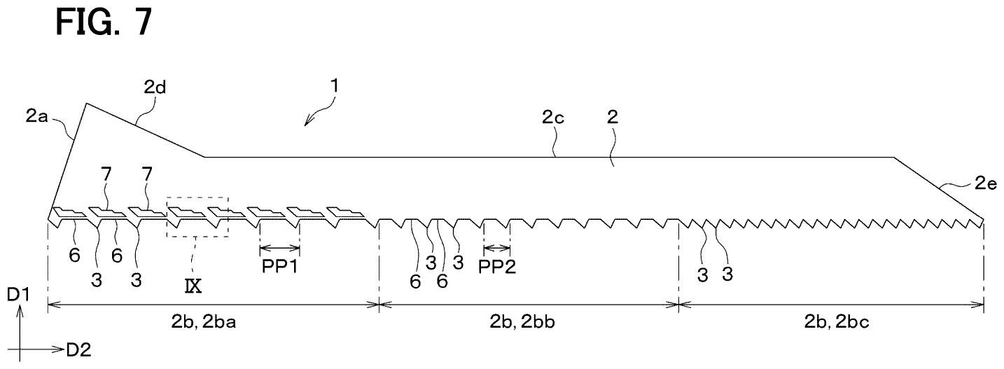

The optical member 1 of the second embodiment will be described with reference to FIGS. 7 to 10.

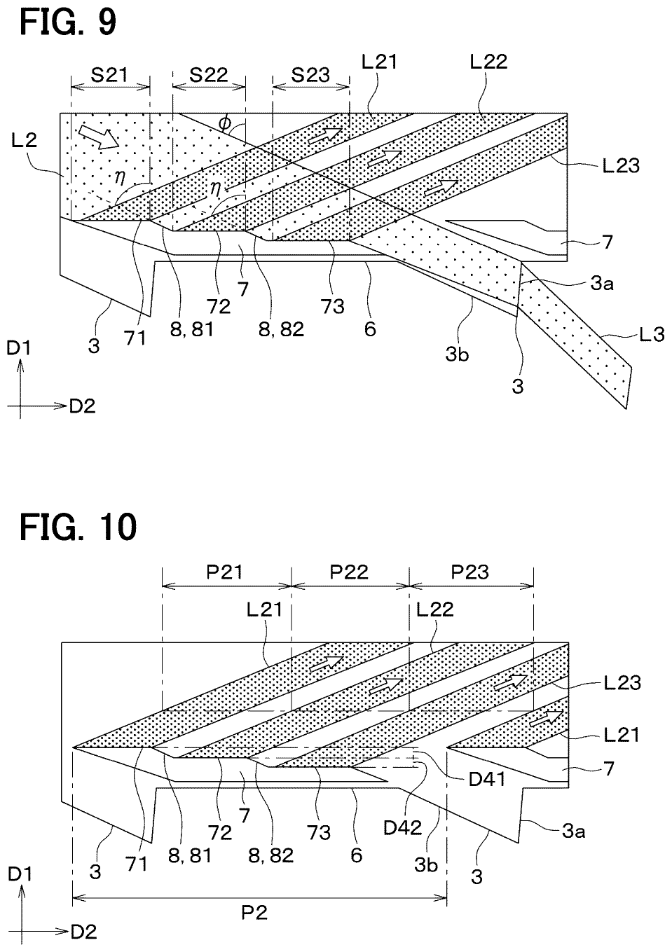

In FIGS. 9 and 10, for the same purpose as FIG. 3, the incident light L2 and the reflected lights L21 to L23 on the optical member 1 are hatched, and the traveling direction of light is shown by a blank arrow.

The optical member 1 of this embodiment differs from the first embodiment in that the configuration of the exit section 2b is changed and that a refractive index difference layer 7 is provided inside the light guide 2, as shown in FIG. 7. This different point will be mainly described in the present embodiment.

In the present embodiment, the exit section 2b is formed by, for example, the prism parts 3 and the flat parts 6 arranged alternately and repeatedly in the first region 2ba in the same way as the second region 2bb. The prism pitch PP1 of the prism parts 3 in the first region 2ba is larger than the prism pitch PP2 of the prism parts 3 in the second region 2bb. In the first region 2ba, in this embodiment, the refractive index difference layer 7 having a refractive index lower than that of the light guide 2 is formed inside the light guide 2 at location near the flat part 6 adjacent to the exit section 2b. The flat parts 6 located in the first region 2ba may be covered with a light shielding film, in order to restrict the external light from entering the inside from the exit section 2b, not to function as internal reflective surface.

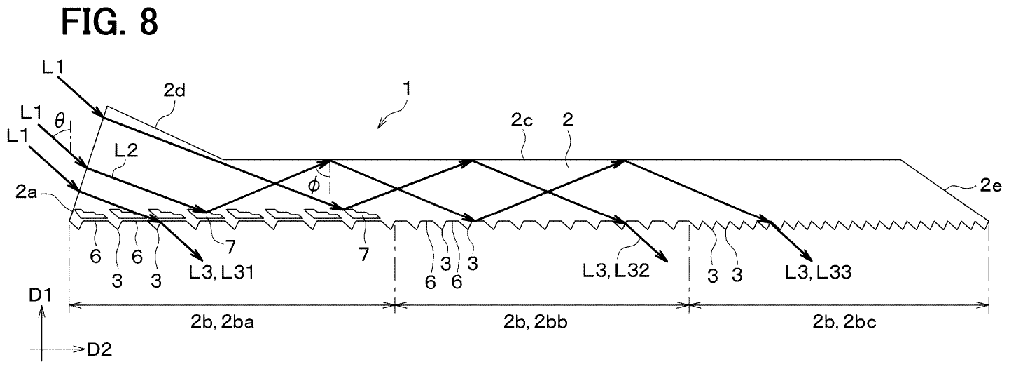

In the optical member 1, as shown in FIG. 8, a part of the incident light L2 is totally reflected at the interface between the light guide 2 and the refractive index difference layer 7 in the first region 2ba toward the smooth surface 2c, and the remaining part passes through the gap between the refractive index difference layers 7 to be emitted to the outside from the exit surface 3a of the prism part 3. The incident light L2 that has entered the refractive index difference layer 7 is divided and reflected by the flat surfaces 71 to 73 of the refractive index difference layer 7, which will be described later. The incident light L2 reflected by the refractive index difference layer 7 is totally reflected by the smooth surface 2c, as in the first embodiment, and then guided to the second region 2bb or the third region 2bc to be emitted to outside from the prism part 3.

The refractive index difference layer 7 is composed of, for example, a low refractive index material having a refractive index n₁ (<n₀) that is relatively lower than that of the light guide 2, or an air layer. As a result, the refractive index difference layer 7 satisfies the total reflection condition of sin φ>n₁/n₀ or sin φ>1/n₀, and the incident light L2 incident on the flat surface 71 to 73 is reflected. As shown in FIG. 9, the refractive index difference layer 7 includes the flat surfaces 71 to 73 substantially parallel to the smooth surface 2c, and a step portion 8 that connects the flat surfaces. The refractive index difference layer 7 has, for example, the first flat surface 71, the first step portion 81, the second flat surface 72, the second step portion 82, and the third flat surface 73 in this order from the entrance surface 2a, on the side opposite to the exit section 2b. The refractive index difference layer 7 has, for example, the flat surfaces 71 to 73 at different height positions. From the viewpoint of securing the area of the exit surface 3a in the first region 2ba, it is preferable that the height position is lowered as the flat surface approaches the terminal surface 2e, that is, closer to the exit section 2b.

In the present embodiment, the light guide 2 is formed by molding from the smooth surface 2c to a surface that will become the flat surfaces 71 to 73 and the step portions 81 and 82 of the refractive index difference layer 7, for example, using a mold (not shown). After that, the remaining part can be manufactured using a resin molding method, using a different mold.

The first flat surface 71 is located the highest among the height positions of the flat surfaces of the refractive index difference layer 7, and is a reflective surface to reflect a part of the incident light L2 as the first reflected light L21 by total internal reflection. The second flat surface 72 is a reflective surface, whose height position is between the first flat surface 71 and the third flat surface 73, to reflect a part of the incident light L2 as the second reflected light L22 by total internal reflection. The third flat surface 73 is located the lowest among the height positions of the flat surfaces of the refractive index difference layer 7, to reflect a part of the incident light L2 as the third reflected light L23 by total internal reflection. The flat surfaces 71 to 73 are arranged across the step portion 8 in the light guiding direction D2, and divide the incident light L2 into plural lights and reflect the lights toward the smooth surface 2c.

Each of the first step portion 81 and the second step portion 82 has a planar shape with an inclined surface inclined at an inclination angle n with respect to the thickness direction D1. It is preferable that the inclination angle η satisfies the relationship of η≤φ to be smaller than or equal to the light guide angle φ of the incident light L2, in a manner that the first step portion 81 and the second step portion 82 do not interfere with the incidence of the incident light L2 on the second flat surface 72 and the third flat surface 73.

The shape and size of the other portion of the refractive index difference layer 7 other than the flat surfaces 71 to 73 and the step portions 81 and 82 may vary not to interfere with the incident light L2 toward the exit surface 3a of the prism part 3. Further, the refractive index difference layer 7 is arranged not located on a virtual straight line passing through the exit surface 3a of the prism part 3 and angled with the light guide angle φ of the incident light L2 relative to the thickness direction D1. Further, the refractive index difference layer 7 is arranged at a position where the distance from the flat part 6 in the thickness direction D1 is lower than or equal to a predetermined value so as not to cause unintended reflection within the light guide 2 or not to interfere with the reflected lights L21 to L23 generated by the other refractive index difference layers 7. Further, in the refractive index difference layer 7, the number of step portions is k (k: an integer of 1 or more), and the number of flat surfaces is k+1, where k is arbitrary.

As shown in FIG. 10, the pitch interval between the reflected lights L21 and L22 is set to P21, and the pitch interval between the reflected lights L22 and L23 is set to P22. Moreover, the pitch interval between the third reflected light L23 and the first reflected light L21 of the adjacent refractive index difference layer 7 adjacent to the refractive index difference layer 7 is set to P23. At this time, each of the pitch intervals P21 to P23 is set to be less than or equal to a half of the pitch interval P2 of the refractive index difference layers 7 adjacent to each other in the light guiding direction D2. Thereby, in the optical member 1, the pitch intervals P21 to P23, when the reflected lights L21 to L23 reach the second region 2bb, are significantly different from the prism pitch PP2, and the effect of reducing moire can be obtained.

Further, as shown in FIG. 9, the widths of the reflected lights L21 to L23 in the light guiding direction D2 are defined respectively S21, S22, and S23. As shown in FIG. 10, the lengths of the step portions 81, 82 in the thickness direction D1 are defined respectively as D41 and D42. At this time, the pitch interval P21 is expressed by Formula 5 in the first region 2ba, and the pitch interval P22 is expressed by Formula 6 in the first region 2ba.

$$P 21 = S 21 + 2 \times D 41 \times tan φ \qquad ( Formula 5 )$$

$$P 22 = S 22 + 2 \times D 42 \times tan φ \qquad ( Formula 6 )$$

The pitch intervals P21 to P23 do not need to be substantially the same. However, when they are substantially the same, the light quantity of the emitted light L3 can be made substantially uniform.

The present embodiment also provides the optical member 1 that can achieve the effects similar to those of the first embodiment. Further, the optical member 1 of this embodiment has the refractive index difference layer 7 inside the light guide 2, and the flat surfaces 71 to 73 of the refractive index difference layer 7 function as reflective surfaces in the first region 2ba. Because of this configuration, it is possible to cover the flat part 6 of the first region 2ba with a light shielding film (not shown). Therefore, the optical member 1 of the present embodiment also has the effect of reducing the influence of intrusion of external light from the exit section 2b in the first region 2ba.

### Modification of Second Embodiment

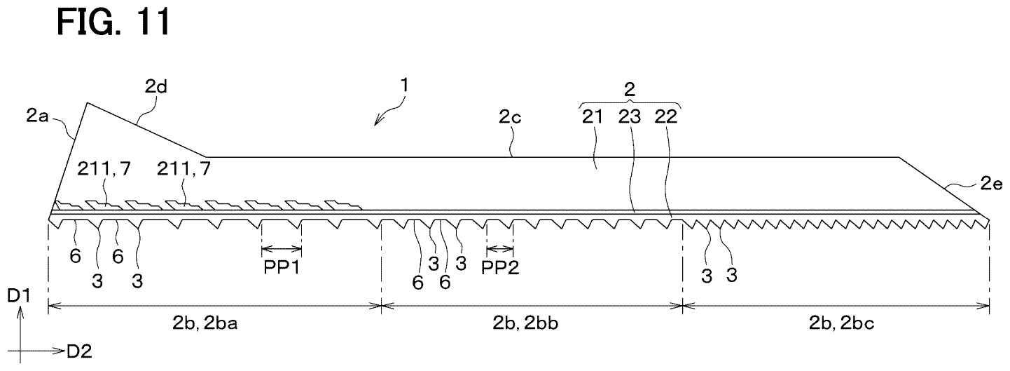

For example, as shown in FIG. 11, in the optical member 1, the light guide 2 includes a base portion 21, a prism sheet 22, and a transparent adhesive layer 23 bonding the base portion 21 and the prism sheet 22.

The base portion 21 includes a portion of the entrance surface 2a, the smooth surface 2c, the sloped surface 2d, a portion of the terminal surface 2e, and a cavity 211 that constitutes the refractive index difference layer 7. The prism sheet 22 includes the remaining part of the entrance surface 2a, the exit section 2b, the remaining part of the terminal surface 2e, and a flat part facing the base portion 21. The flat part is connected to the base portion 21 via the transparent adhesive layer 23. The base portion 21 and the prism sheet 22 are formed separately, for example, by a resin molding method using a mold (not shown). The transparent adhesive layer 23 is made of, for example, an optical adhesive such as OCA or OCR, and has the same refractive index as the constituent materials of the base portion 21 and the prism sheet 22. The OCA and OCR are abbreviations for Optical Clear Adhesive and Optical Clear Resin, respectively. Further, in this case, the refractive index difference layer 7 is composed of, for example, an air layer existing in the cavity 211, but may be composed by filling the cavity 211 with a material having a lower refractive index than the base portion 21.

This modification also provides the optical member 1 that can achieve the effects similar to those of the second embodiment. Further, by configuring the light guide 2 with plural members, the manufacturing can be facilitated.

### Third Embodiment

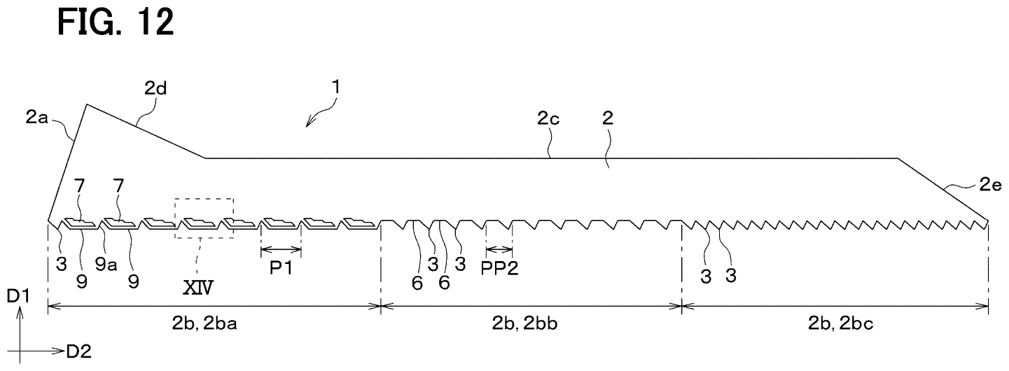

The optical member 1 of the third embodiment will be described with reference to FIGS. 12 to 15.

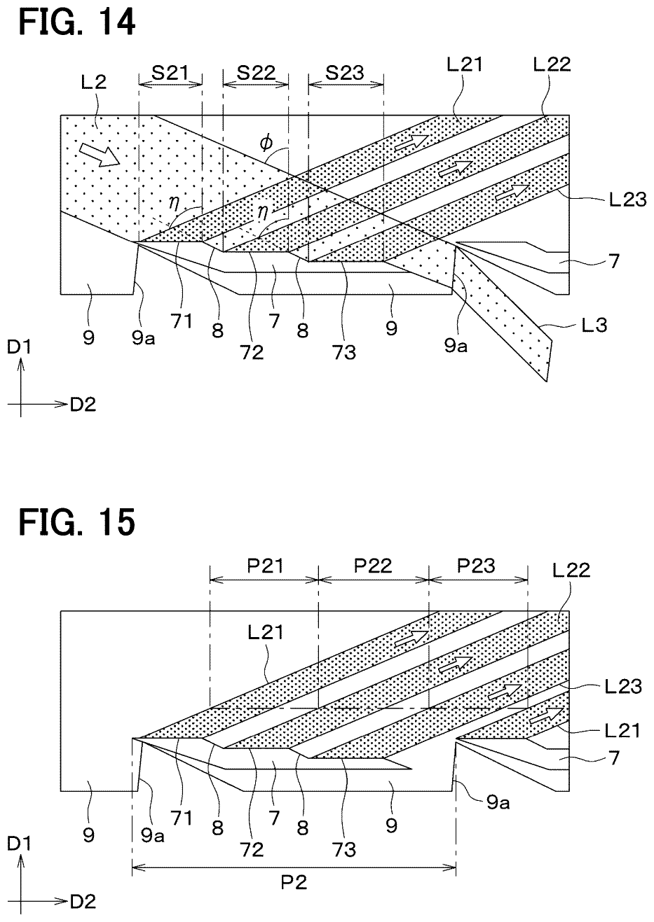

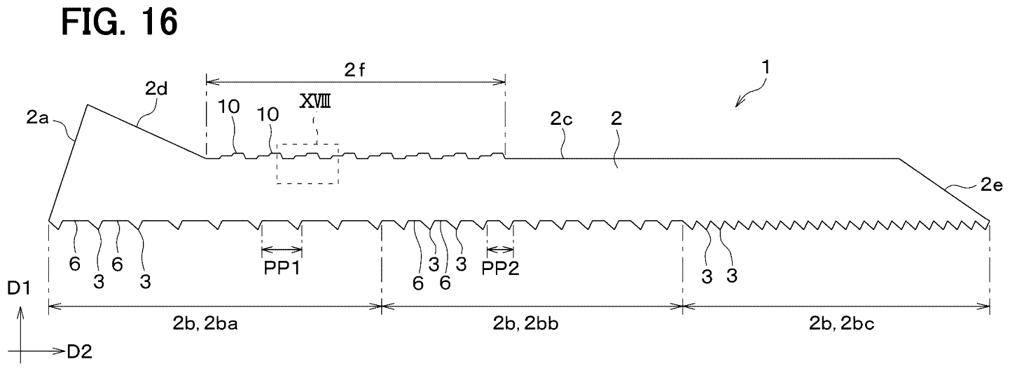

In FIGS. 14 and 15, for the same purpose as FIG. 3, the incident light L2 and the reflected lights L21 to L23 are hatched in the optical member 1, and the traveling direction of light is shown by a blank arrow.

The optical member 1 of this embodiment, as shown in FIG. 12, differs from that of the first embodiment in that the protrusions 9 having the exit surface 9a are arranged in the first region 2ba of the exit section 2b and that the refractive index difference layer 7 is formed within the protrusion 9 inside the light guide 2. This different point will be mainly described in the present embodiment. Furthermore, since the configuration of the refractive index difference layer 7 is basically the same as that of the second embodiment, this embodiment will mainly explain the differences.

In this embodiment, the refractive index difference layer 7 is partially or entirely formed within the protrusion 9. The refractive index difference layer 7 has the flat surfaces 71 to 73 and the step portions 81 and 82, and the first flat surface 71 is at the same height position as the flat part 6 of the second region 2bb. The refractive index difference layer 7 is configured such that the height position is lowered as the flat surfaces 71 to 73 approach the terminal surface 2e, in other words, the exit section 2b. For example, the refractive index difference layer 7 is arranged not located on a virtual straight line passing through the exit surface 9a of the protrusion 9 and inclined at the light guide angle φ of the incident light L2, with respect to the thickness direction D1.

The protrusion 9 has a trapezoidal shape in the cross-sectional view, as shown in FIG. 12. The inclined surface of the protrusion 9 located adjacent to the terminal surface 2e is the exit surface 9a parallel to the entrance surface 2a. The plural protrusions 9 are repeatedly arranged along the light guiding direction D2 in the first region 2ba and are arranged parallel to each other.

The protrusion 9 is not limited to a trapezoidal shape, and may have a shape with the exit surface 9a not to obstruct the emitted light L3 from the exit surface 9a of the adjacent protrusion 9. Furthermore, in order to restrict the external light from entering the light guide 2 from the exit section 2b, the protrusion 9 may be covered with a light-shielding film (not shown) other than the exit surface 9a.

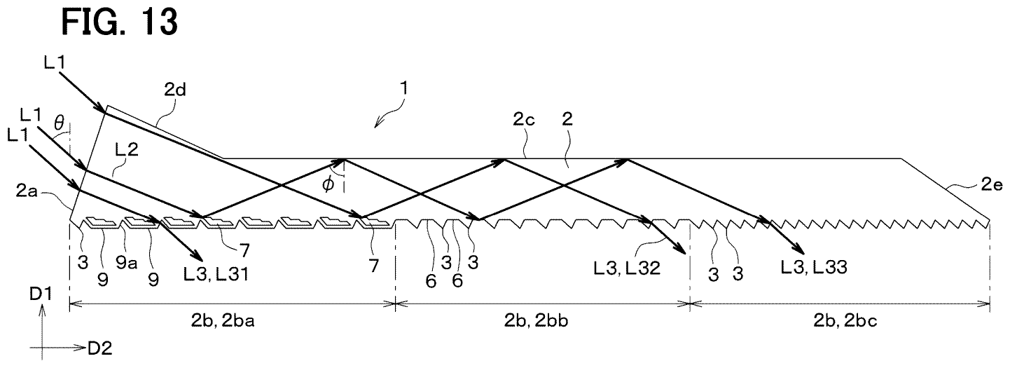

In the present embodiment, as shown in FIGS. 13 and 14, in the first region 2ba, a part of the incident light L2 from the entrance surface 2a is divided and reflected at the flat surfaces 71 to 73 of the refractive index difference layer 7, and the remaining part is emitted from the exit surface 9a of the protrusion 9 to the outside. In the first region 2ba, a part of the incident light L2 is divided into the first reflected light L21, the second reflected light L22, and the third reflected light L23 by the flat surfaces 71 to 73, and reflected onto the smooth surface 2c. In the second region 2bb and the third region 2bc, the optical member 1 reflects a part of the incident light L2 on the smooth surface 2c and the flat part 6, and the remaining part is emitted from the prism part 3 to the outside.

In this embodiment, as shown in FIG. 15, the pitch intervals P21 to P23 of the reflected lights L21 to L23 in the light guiding direction D2 do not need to be substantially the same, as in the second embodiment. From the viewpoint of substantially uniformizing the light amount of the emitted light L3 at the exit section 2b, it is preferable that the light intensity is substantially the same. In this case, the widths S21 to S23 of the reflected lights L21 to L23 in the light guiding direction D2, the inclination angle η and the lengths D41 and D42 of the step portions 81 and 82 in the thickness direction D1, and the pitch interval P2 of the refractive index difference layers 7 in the light guiding direction D2 are designed similarly to the second embodiment.

The present embodiment also provides the optical member 1 that can achieve the effects similar to those of the second embodiment. Furthermore, by providing the protrusion 9 with a high degree of freedom in shape and configuration in portions other than the exit surface 9a, it is expected that manufacturing costs will be reduced more than in the second embodiment.

### Fourth Embodiment

The optical member 1 of the fourth embodiment will be described with reference to FIGS. 16 to 19.

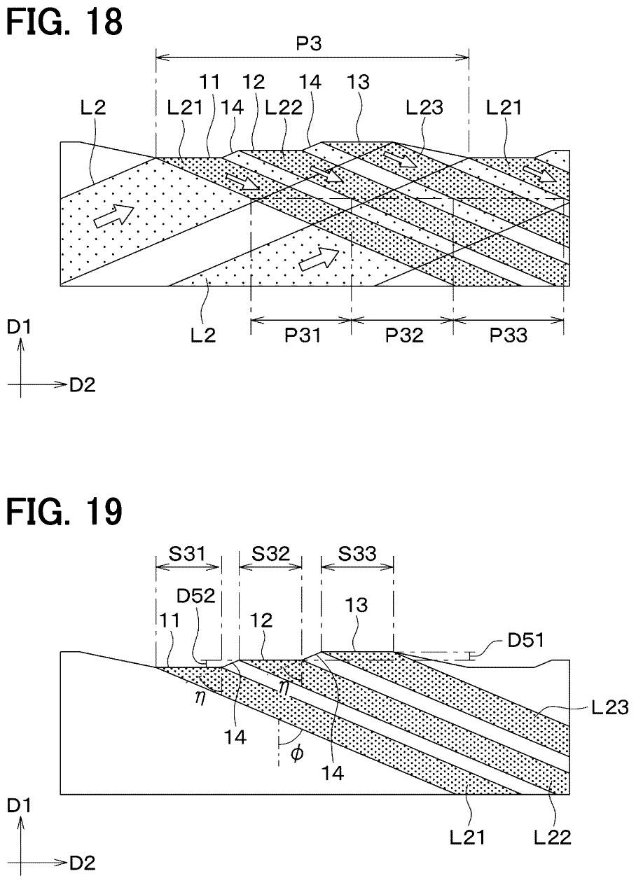

In FIGS. 18 and 19, for the same purpose as FIG. 3, the incident light L2 and the reflected lights L21 to L23 in the optical member 1 are hatched, and the traveling direction of light is shown by a blank arrow.

In the optical member 1 of this embodiment, as shown in FIG. 16, the first region 2ba of the exit section 2b has the same configuration as the second region 2bb. The optical member 1 further includes a dividing reflection section 2f composed of step-shaped reflective surfaces 10 between the smooth surface 2c and the sloped surface 2d, differently from the first embodiment. This different point will be mainly described in the present embodiment.

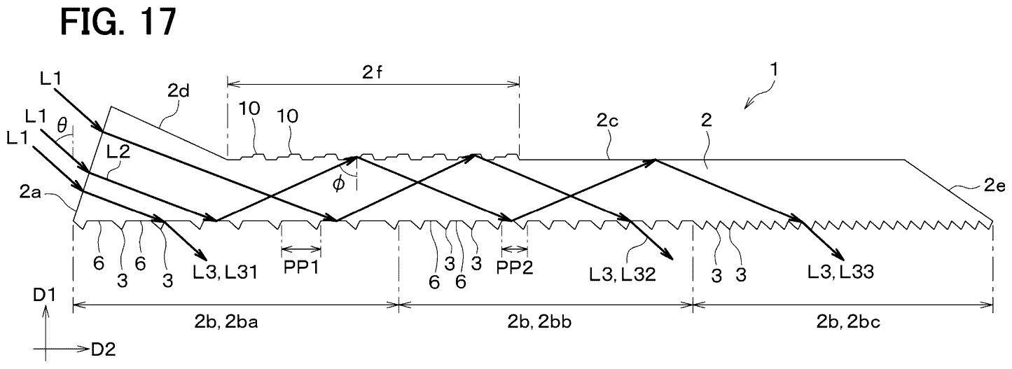

In this embodiment, the exit section 2b has the prism parts 3 and the flat parts 6 alternately and repeatedly arranged, and the prism pitch PP1 in the first region 2ba is larger than the prism pitch PP2 of the second region 2bb, as in the second embodiment. In the first region 2ba, in this embodiment, as shown in FIG. 17, the flat part 6 reflects a part of the incident light L2 to the dividing reflection section 2f, and the prism part 3 emits the remaining part of the incident light L2 to the outside.

The dividing reflection section 2f is formed by repeatedly arranging the plural step-shaped reflective surfaces 10 along the light guiding direction D2. As shown in FIG. 18, the dividing reflection section 2f divides the incident light L2 by the plural reflective surfaces 11 to 13 of the step-shaped reflective surface 10, and reflects the reflected lights L21 to L23 toward the second region 2bb of the exit section 2b. The width of the dividing reflection section 2f in the light guiding direction D2 is less than or equal to the width of the first region 2ba in the light guiding direction D2.

The step-shaped reflective surface 10 includes a first reflective surface 11, a second reflective surface 12, and a third reflective surface 13 substantially parallel to the flat part 6, and a step portion 14 that connects the adjacent reflective surfaces. In the step-shaped reflective surface 10, the first reflective surface 11, the second reflective surface 12, and the third reflective surface 13 have different height positions. The reflective surfaces 11 to 13 are configured such that the height position is made higher as approaching the terminal surface 2e, in other words, separating from the light guide 2. The first reflective surface 11 is located at the same height as the smooth surface 2c. The second reflective surface 12 is located higher than the first reflective surface 11 and the smooth surface 2c, and the third reflective surface 13 is located higher than the second reflective surface 12. Further, in the step-shaped reflective surface 10, as shown in FIG. 19, the inclination angle η of the step portion 14 with respect to the thickness direction D1 is equal to or less than the light guide angle φ of the incident light L2. As a result, the step-shaped reflective surface 10 allows the first reflective surface 11, the second reflective surface 12, and the third reflective surface 13 to reflect a part of the incident light L2 reflected on the first region 2ba without being blocked by the step portion 14. Therefore, the loss of the light beam can be suppressed.

The step portion 14 does not need to obstruct the incident light L2 toward the second reflective surface 12 and the third reflective surface 13, and is not limited to a planar shape, but may have a curved shape or a composite shape having a planar portion and a curved portion.

As shown in FIG. 18, the reflected lights on the reflective surfaces 11 to 13 are respectively designated as the first reflected light L21, the second reflected light L22, and the third reflected light L23. The pitch intervals of the reflected lights L21 to L23 are set in the light guiding direction D2 as P31, P32, and P33, respectively. The pitch interval P31 is defined between the first reflected light L21 and the second reflected light L22, and the pitch interval P32 is defined between the second reflected light L22 and the third reflected light L23. The pitch interval P33 is defined between the third reflected light L23 and the first reflected light L21 of the adjacent step-shaped reflective surface 10.

At this time, the step-shaped reflective surface 10 is configured such that each of the pitch intervals P31 to P33 is less than or equal to a half of the pitch interval P3 of the step-shaped reflective surfaces 10 in the light guiding direction D2. Further, the step-shaped reflective surfaces 10 are provided in such a manner that the pitch interval P3 is equal to or less than the prism pitch PP1 in the first region 2ba. The number of the step-shaped reflective surfaces 10 is equal to the number of flat parts 6 in the first region 2ba. As a result, in the optical member 1 of the present embodiment, all of the incident light L2 reflected by the first region 2ba enters the dividing reflection section 2f, and is divided into the reflected lights L21 to L23 having the pitch intervals P31 to P33 which are significantly different from the prism pitch PP2 in the second region 2bb. Therefore, the optical member 1 is configured to reduce moire in the second region 2bb.

The pitch intervals P31 to P33 of the reflected lights L21 to L23 do not need to be substantially the same, but are preferably substantially the same from the viewpoint of making the amount of the emitted light L3 substantially uniform at the exit section 2b. In this case, the widths S31 to S33 of the reflected lights L21 to L23 in the light guiding direction D2, the inclination angle η of the step portion 14, and the lengths D51 and D52 in the thickness direction D1 are designed in the same manner as in the second embodiment.

The present embodiment also provides the optical member 1 that can achieve the effects similar to those of the first embodiment. Moreover, since this optical member 1 does not have a step portion with an inclination angle η in the first region 2ba of the exit section 2b, the external light from the exit section 2b is suppressed from entering the light guide 2, so as to reduce the occurrence of ghost images.

### Other Embodiments

Although the present disclosure has been described in accordance with the embodiments, it is understood that the present disclosure is not limited to such embodiments or structures. The present disclosure also includes various modifications and modifications within an equivalent range. In addition, various combinations and modes, and further, other combinations and modes including one element of these alone, or thereabove, or therebelow, are also comprised within the scope or concept range of the present disclosure.

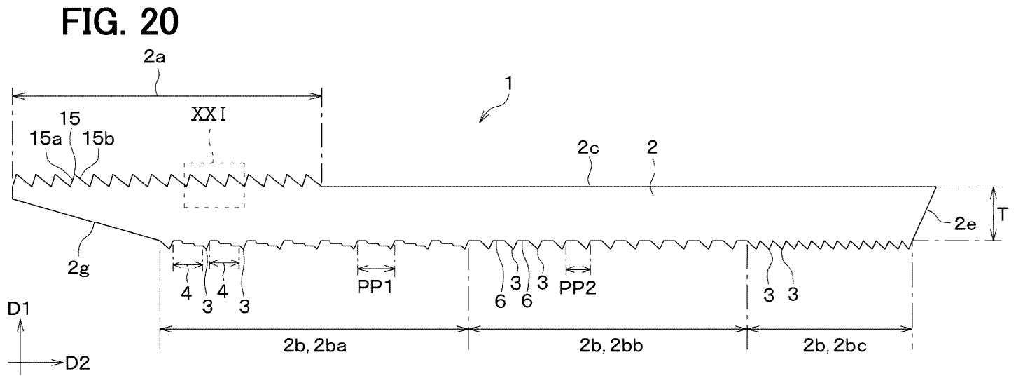

(1) In the optical member 1, for example, as shown in FIG. 20, the arrangement and configuration of the entrance surface 2a may be modified. Specifically, the entrance surface 2a may be disposed adjacent to the smooth surface 2c and opposite to the exit section 2b together with the smooth surface 2c. In this optical member 1, the entrance surface 2a and the smooth surface 2c are substantially in parallel with the exit section 2b, and further has an entrance side surface 2g located opposite to the terminal surface 2e to connect the entrance surface 2a and the exit section 2b. In this case, the entrance surface 2a protrudes from the smooth surface 2c, and includes plural triangular protruding entrance prism parts 15 when viewed in the cross section. The entrance surface 2a is composed only of the entrance prism parts 15 repeatedly arranged along the light guiding direction D2. The entrance side surface 2g does not need to restrict the incident light L2 from the entrance surface 2a from entering the exit section 2b, and the surface shape and inclination can be changed as appropriate. The entrance side surface 2g may be covered with a light-shielding film (not shown) to restrict unintended incidence of external light.

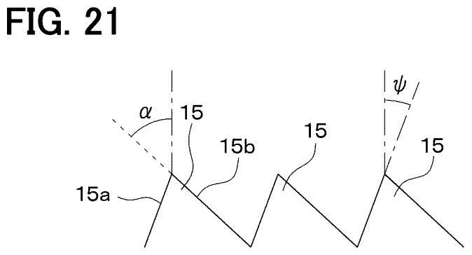

As shown in FIG. 21, the entrance prism part 15 has an entrance section 15a opposite to the terminal surface 2e and parallel to the exit surface 3a of the prism part 3. The entrance prism part 15 has an adjacent surface 15b adjacent to the entrance section 15a with an inclination angle of a with respect to the thickness direction D1. In the entrance prism part 15, when the inclination angle of the external light L1 incident on the entrance section 15a is defined as θ, and when the inclination angle of the entrance section 15a with respect to the thickness direction D1 is defined as ψ, the inclination angle α of the adjacent surface 15b is designed to satisfy θ<α<ψ. As a result, the external light L1 enters the entrance section 15a without being obstructed by the adjacent surface 15b, and a gap is suppressed from being generated in the incident light L2 between the entrance prism parts 15. Thus, the entrance surface 2a can be provided to reduce loss of light rays.

The above-mentioned modification of the optical member 1 has been shown as an example applied to the first embodiment, but is not limited to this, and may be applied to embodiments other than the first embodiment and their modifications.

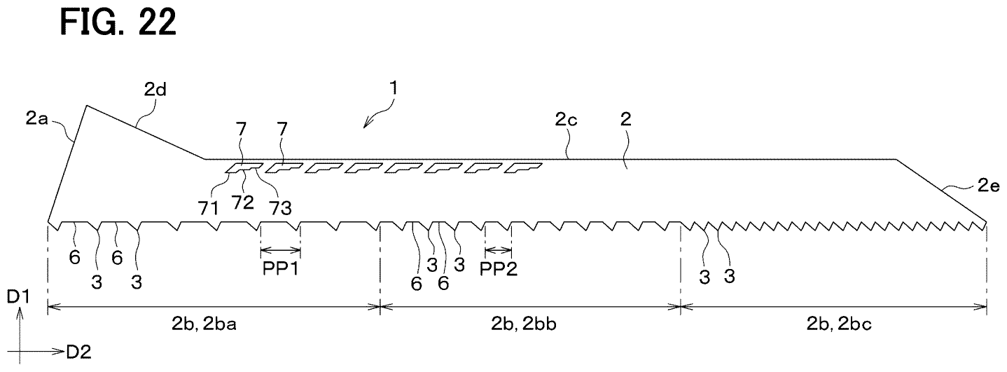

(2) In the optical member 1, for example, as shown in FIG. 22, the exit section 2b has the same configuration as in the second embodiment, and the arrangement of the plural refractive index difference layers 7 inside the light guide 2 may be changed to the vicinity of the smooth surface 2c. In this case, the refractive index difference layer 7 is disposed near the smooth surface 2c and the sloped surface 2d, in a predetermined region where the incident light L2 reflected at the first region 2ba enters. The refractive index difference layer 7 is arranged in order of the first flat surface 71, the second flat surface 72, and the third flat surface 73 from the entrance surface 2a toward the terminal surface 2e, and the height position is made upward as closer to the terminal surface 2e, that is, closer to the smooth surface 2c. Further, the refractive index difference layer 7 may be arranged in plural or one layer in which the first flat surface 71, the second flat surface 72, and the third flat surface 73 are repeatedly arranged in this order.

Also in this modification, the optical member 1 can reduce moire, similar to the first embodiment. In other words, the optical member 1 can divide the incident light L2 into plural reflected lights having a pitch significantly different from the prism pitch PP2 in the second region 2bb at a point between the first region 2ba and the second region 2bb of the exit section 2b.

(3) The constituent element(s) of each of the embodiment(s) described above is/are not necessarily essential unless it is specifically stated that the constituent element(s) is/are essential in the embodiment(s), or unless the constituent element(s) is/are obviously essential in principle. Further, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. In each of the above embodiments, when the shape, positional relationship, and the like of the constituent elements and the like are referred to, the shape, the positional relationship, and the like are not limited unless otherwise specified or limited to specific shapes, positional relationships, and the like in principle.

What is claimed is:

1. An optical member configured to internally reflect and guide an external light, the optical member comprising:
a light guide made of a light-transmitting material and having an entrance surface on which the external light is incident, an exit section that outputs a part of light incident from the entrance surface to outside, a smooth surface opposite to the exit section, and a terminal surface located opposite to the entrance surface to connect the exit section and the smooth surface, wherein
the exit section has a first region adjacent to the entrance surface and a second region adjacent to the first region,
the first region has a plurality of step-shaped reflective surface and a plurality of protruding prism parts alternately arranged adjacent to each other,
the step-shaped reflective surface has a plurality of flat surfaces opposite to the smooth surface and located at different heights through a step portion,
the second region has a plurality of prism parts and a plurality of flat parts alternately arranged adjacent to each other, one flat surface being defined by the plurality of flat parts,
the flat surfaces, the flat parts, and the smooth surface reflect a part of incident light that is incident into the light guide from the entrance surface by total reflection, and
the prism part has an exit surface that outputs a part of the incident light to outside.

2. The optical member according to claim 1, wherein
a thickness direction is defined to connect the flat part and the smooth surface along a normal direction to the flat part, and to extend downward from the smooth surface to the flat part, positions of the flat surfaces in the thickness direction is defined as height positions, and
the height positions of the plurality of flat surfaces become downward in the step-shaped reflective surface as approaching the terminal surface.

3. The optical member according to claim 1, wherein
a light guiding direction is defined to extend from the entrance surface toward the terminal surface along an arrangement direction of the flat parts and the prism parts, on a plane formed by the flat parts, and
in the first region, a width of each of the plurality of flat surfaces in the light guiding direction is equal to or less than a half of a pitch interval of the prism parts adjacent to each other.

4. An optical member configured to internally reflect and guide an external light, the optical member comprising:
a light guide made of a light-transmitting material and having an entrance surface on which the external light is incident, an exit section that outputs a part of light incident from the entrance surface to outside, a smooth surface opposite to the exit section, and a terminal surface located opposite to the entrance surface to connect the exit section and the smooth surface, wherein the exit section has a plurality of protruding prism parts and a plurality of flat parts that define a flat surface; and
a plurality of refractive index difference layers having a refractive index lower than that of the light guide and located in a region where at least an incident light that is incident from the entrance surface directly enters, adjacent to the exit section inside of the light guide, wherein
each of the plurality of refractive index difference layers has a plurality of flat surfaces located at different heights through a step portion, opposite to a plane formed by the smooth surface,
the flat surfaces, the flat parts, and the smooth surface reflect a part of the incident light by total reflection,
the prism part has an exit surface that outputs a part of the incident light to outside, and
the plurality of refractive index difference layers are distanced from each other so as not to block the incident light that enters the exit surface.

5. The optical member according to claim 4, wherein
a thickness direction is defined to connect the flat part and the smooth surface along a normal direction to the flat part, and to extend downward from the smooth surface to the flat part, positions of the flat surfaces in the thickness direction is defined as height positions, and
the height positions of the plurality of flat surfaces become downward in the refractive index difference layer as approaching the terminal surface.

6. The optical member according to claim 4, wherein
a light guiding direction is defined to extend from the entrance surface toward the terminal surface along an arrangement direction of the flat parts and the prism parts, on a plane formed by the flat parts, and
in the refractive index difference layer, a width of each of the plurality of flat surfaces in the light guiding direction is equal to or less than a half of a pitch interval of the refractive index difference layers adjacent to each other.

7. The optical member according to claim 4, wherein the refractive index difference layer is an air layer.

8. An optical member configured to internally reflect and guide an external light, the optical member comprising:
a light guide made of a light-transmitting material and having an entrance surface on which the external light is incident, an exit section that outputs a part of light incident from the entrance surface to outside, a smooth surface and a dividing reflection section opposite to the exit section, and a terminal surface located opposite to the entrance surface to connect the exit section and the smooth surface, wherein the exit section has a plurality of protruding prism parts and a plurality of flat parts that form a flat surface,
the dividing reflection section is located adjacent to the smooth surface and between the entrance surface and the smooth surface,
the dividing reflection section has a plurality of step-shaped reflective surfaces arranged adjacent to each other,
each of the plurality of step-shaped reflective surfaces has a plurality of reflective surfaces located at different heights through a step portion, opposite to a surface formed by the plurality of flat parts,
the reflective surfaces, the flat parts, and the smooth surface reflect a part of incident light that is incident on the light guide from the entrance surface by total reflection, and
the prism part has an exit surface that outputs a part of the incident light to outside.

9. The optical member according to claim 8, wherein
a thickness direction is defined to connect the flat part and the smooth surface along a normal direction to the flat part, and to extend upward from the flat part to the smooth surface, positions of the reflective surfaces in the thickness direction is defined as height positions, and
the height positions of the plurality of reflective surfaces become upward in the step-shaped reflective surface as approaching the terminal surface.

10. The optical member according to claim 8, wherein
a light guiding direction is defined to extend from the entrance surface toward the terminal surface along an arrangement direction of the flat parts and the prism parts, on a plane formed by the flat part, and
in the step-shaped reflective surface, a width of each of the plurality of reflective surfaces in the light guiding direction is equal to or less than a half of a pitch interval of the step-shaped reflective surfaces adjacent to each other.

11. The optical member according to claim 8, wherein
a light guiding direction is defined to extend from the entrance surface toward the terminal surface along an arrangement direction of the flat parts and the prism parts, on a plane formed by the flat part, and
a width of the dividing reflection section in the light guiding direction is less than or equal to a width of a region of the exit section where an incident light that is incident from the entrance surface directly enters in the light guiding direction.
